(19) United States
(12) Patent Application Publication
(10) Pub. No.: US 2013/0203889 A1
(43) Pub. Date: Aug. 8, 2013

(54) Tire the Tread of which Comprises a Thermoplastic Elastomer

(71) Applicants: Garance Lopitaux, Valignat (FR); Franck Varagnat, Ceyrat (FR)

(72) Inventors: Garance Lopitaux, Valignat (FR); Franck Varagnat, Ceyrat (FR)

(73) Assignees: Michelin Recherche et Technique S.A., Granges-Paccot (CH); Compagnie Generale Des Etablissements Michelin, Clermont-Ferrand (FR)

(21) Appl. No.: 13/582,942

(22) PCT Filed: Mar. 1, 2011
(86) PCT No.: PCT/EP2011/052963

§ 371 Date: Dec. 10, 2012

(30) Foreign Application Priority Data
Mar. 5, 2010 (FR) 1051600

(51) Int. Cl. C08L 9/06

(52) U.S. Cl. CPC C08L 9/06
USPC 523/156

(57) ABSTRACT

A tire whose tread comprises a rubber composition comprising at least one diene elastomer, for instance an SBR, a reinforcing filler, for instance a silica, and a polyether block amide (PEBA) thermoplastic elastomer. Such a composition has a reduced raw-state viscosity, thus promoting the processability of the treads, while at the same time conserving a good level of dry road holding and of rolling resistance.

The present invention relates to tire treads and to rubber compositions based on diene elastomer and thermoplastic elastomer, which may be used for the manufacture of such tire treads.

As is known, a tire must obey a large number of technical requirements, which are often antinomic, among which are high wear strength, low rolling resistance and high road holding, both on dry and wet roads.

This compromise of properties, in particular from the point of view of the rolling resistance and the road holding, has been able to be improved in recent years on low-energy-consumption “green tires”, which are intended especially for private cars, by virtue especially of the use of novel low-hysteresis rubber compositions which have the characteristic of being predominantly reinforced with specific inorganic fillers termed “reinforcing fillers”, especially highly dispersible silicas (HDS), which are capable of competing, from the point of view of the reinforcing power, with conventional tire-grade carbon blacks.

The use (or “processability”) in the raw state of rubber compositions containing such inorganic fillers, especially HDS silicas, nevertheless remains more difficult than for rubber compositions conventionally filled with carbon black. This difficulty is due, as is known, to a high surface reactivity of the inorganic filler particles, and thus a high natural tendency of these particles to aggregate together, thus reducing the dispersibility of the filler in the rubber matrix.

This processability is all the more difficult when it is desired to appreciably increase the content of reinforcing filler in order to further increase the level of reinforcement of rubber compositions and especially their wear strength and their road holding.

Thus, the improvement in the processability of the rubber compositions of tire treads, comprising high contents of reinforcing filler, remains a constant preoccupation of tire designers.

In the course of their research, the Applicants have discovered a novel rubber composition, based on a diene elastomer, a specific thermoplastic elastomer and a reinforcing filler that makes it possible to obtain tire treads that have improved raw-state processing.

Thus, the invention relates to a tire whose tread comprises a rubber composition comprising at least one diene elastomer, a reinforcing filler and a polyether block amide thermoplastic elastomer.

The tires of the invention are particularly intended to equip motor vehicles such as private cars, SUVs (sport utility vehicles), two-wheeled vehicles (especially motorbikes), aircraft, industrial vehicles chosen from vans, heavy-goods vehicles, i.e. underground railway carriages, buses, road haulage vehicles (trucks, tractors or trailers), off-road vehicles such as agricultural machines or civil engineering machines, and other transportation or maintenance vehicles.

The invention and the advantages thereof will be clearly understood in the light of the description and of the implementation examples that follow.

### I—MEASUREMENTS AND TESTS USED

The rubber compositions used in the tires according to the invention are characterized before and after curing, as indicated below.

I-1. Mooney Plasticity:

An oscillating consistometer as described in French standard NF T 43-005 (1991) is used. The Mooney plasticity measurement is performed according to the following principle: the raw composition (i.e. before curing) is moulded in a cylindrical chamber heated to 100° C. After one minute of preheating, the rotor spins inside the specimen at 2 rpm, and the torque needed to maintain this movement after 4 minutes of rotation is measured. The Mooney plasticity (ML 1+4) is expressed in “Mooney units” (MU, with 1 MU=0.83 newton.metre).

I-2. Tensile Tests

These tests make it possible to determine the elasticity constraints and the properties at failure. Unless otherwise indicated, they are performed in accordance with French standard NF T 46-002 of September 1988. The nominal secant moduli (or apparent stresses, in MPa) at 10% elongation are measured in second elongation (i.e. after a cycle of accommodation to the degree of extension envisaged for the measurement itself) (noted MA10). The elongations at failure are also measured (noted AR, in %). All these tensile measurements are performed under normal conditions of temperature (23±2° C.) and of hygrometry (50±5% relative humidity) according to French standard NF T 40-101 (December 1979).

I.3—Dynamic Properties

The dynamic properties are measured on a viscoanalyser (Metravib VA4000) according to standard ASTM D 5992-96. The response of a sample of vulcanized composition (cylindrical specimen 4 mm thick and 400 mm² in cross section) subjected to a sinusoidal stress in simple alternating shear, at a frequency of 10 Hz, during a temperature sweep, under a fixed stress of 0.7 MPa, is recorded, and the value of tan(δ) observed, for example at 20° C. (i.e. tan(δ)_{20°C.}) and at 40° C. (i.e. tan(δ)_{40°C.}) is recorded.

### II—CONDITIONS FOR PERFORMING THE INVENTION

The tire tread according to the invention comprises an elastomeric composition comprising at least one diene elastomer, a reinforcing filler and a polyether block amide (or PEBA) thermoplastic elastomer.

“Pce” means parts by weight per hundred parts of total elastomer, thus including the polyether block amide elastomer.

In the present description, unless expressly indicated otherwise, all the percentages (%) given are mass percentages. Moreover, any range of values denoted by the expression “between a and b” represents the range of values going from more than a to less than b (i.e. the limits a and b are excluded), whereas any range of values denoted by the expression “from a to b” means the range of values gong from a up to b (i.e. including the strict limits a and b).

II.1—Diene Elastomer

The tire tread according to the invention comprises a rubber composition which has the first essential characteristic of comprising at least one diene elastomer.

By the term elastomer (or “rubber”, the two terms being considered as synonymous) of the “diene” type, it is recalled here that what should be understood, in a known manner, is an (which means one or more) elastomer at least partly derived (i.e. a homopolymer or a copolymer) from diene monomers (monomers bearing two conjugated or unconjugated carbon-carbon double bonds).

Diene elastomers may be classified in two categories: “essentially unsaturated” or “essentially saturated”. The term “essentially unsaturated” generally means a diene elastomer at least partly derived from conjugated diene monomers, with a content of units of diene origin (conjugated dienes) that is greater than 15% (in mol %); thus, diene elastomers such as butyl rubbers or copolymers of dienes and of alpha-olefins of EPDM type are not included in the preceding definition and may especially be termed “essentially saturated” diene elastomers (low or very low content of units of diene origin, always less than 15%). In the category of “essentially unsaturated” diene elastomers, the term “highly unsaturated” diene elastomer in particular means a diene elastomer with a content of units of diene origin (conjugated dienes) that is greater than 50%.

These definitions being given, the following are more particularly intended as diene elastomers that may be used in the compositions in accordance with the invention:
(a)—any homopolymer obtained by polymerization of a conjugated diene monomer containing from 4 to 12 carbon atoms;
(b)—any copolymer obtained by copolymerization of one or more dienes that are conjugated together or with one or more vinylaromatic compounds containing from 8 to 20 carbon atoms;
(c)—a ternary copolymer obtained by copolymerization of ethylene, of an α-olefin containing from 3 to 6 carbon atoms with an unconjugated diene monomer containing from 6 to 12 carbon atoms, for instance the elastomers obtained from ethylene, from propylene with an unconjugated diene monomer of the abovementioned type especially such as 1,4-hexadiene, ethylidenenorbornene or dicyclopentadiene;
(d)—a copolymer of isobutene and of isoprene (butyl rubber); and also the halogenated versions, in particular chlorinated or brominated, of this type of copolymer.

Although it applies to any type of diene elastomer, a person skilled in the field of tires will understand that the present invention is preferably performed with essentially unsaturated diene elastomers, in particular of the type (a) or (b) above.

Conjugated dienes that are especially suitable for use include 1,3-butadiene, 2-methyl-1,3-butadiene, 2.3-bis(C₁-C₅ alkyl)-1,3-butadienes, for instance 2,3-dimethyl-1,3-butadiene, 2,3-diethyl-1,3-butadiene, 2-methyl-3-ethyl-1,3-butadiene, 2-methyl-3-isopropyl-1,3-butadiene, aryl-1,3-butadiene, 1,3-pentadiene, 2,4-hexadiene. Vinylaromatic compounds that are suitable for use include, for example, stirene, ortho-, meta- and para-methylstirene, the commercial “vinyl-toluene” mixture, para-tert-butylstirene, methoxystirenes, chlorostirenes, vinylmesitylene, divinylbenzene and vinylnaphthalene.

The copolymers may contain between 99% and 20% by weight of diene units and between 1% and 80% by weight of vinylaromatic units. The elastomers may have any microstructure that is a function of the polymerization conditions used, especially of the presence or absence of a modifying and/or randomizing agent and of the amounts of modifying and/or randomizing agent used. The elastomers may be, for example, block, statistical, sequenced or microsequenced elastomers, and may be prepared in dispersion or in solution; they may be in coupled and/or star form or alternatively functionalized with a coupling and/or star or functionalizing agent. For coupling to carbon black, examples that may be mentioned include functional groups comprising a C—Sn bond or amino functional groups, for instance aminobenzophenone; for coupling to a reinforcing inorganic filler such as silica, examples that may be mentioned include silanol or polysiloxane functional groups with a silanol end (as described, for example, in FR 2 740 778, U.S. Pat. No. 6,013,718 and WO 2008/141 702), alkoxysilane groups (as described, for example, in FR 2 765 882 or U.S. Pat. No. 5,977,238), carboxylic groups (as described, for example, in WO 01/92402 or U.S. Pat. No. 6,815,473, WO 2004/096 865 or US 2006/0 089 445) or alternatively polyether groups (as described, for example, in EP 1 127 909, U.S. Pat. No. 6,503,973, WO 2009/000 750 and WO 2009/000 752). As other examples of functionalized elastomers, mention may also be made of elastomers (such as SBR, BR, NR or IR) of the epoxidized type.

Polybutadienes and in particular those with a content (mol %) of -b 1,2 units of between 4% and 80% or those with a content (mol %) of cis-1,4 of greater than 80%, polyisoprenes, copolymers of butadiene-stirene and in particular those with a Tg (glass transition (Tg, measured according to ASTM D3418) of between 0° C. and −70° C. and more particularly between −10° C. and −60° C., a stirene content of between 5% and 60% by weight and more particularly between 20% and 50%, a content (mol %) of -b 1,2 bonds of the butadiene part of between 4% and 75%, a content (mol %) of trans-1,4 bonds of between 10% and 80%, butadiene-isoprene copolymers and especially those with an isoprene content of between 5% and 90% by weight and a Tg of from −40° C. to −80° C., isoprene-stirene copolymers and especially those with a stirene content of between 5% and 50% by weight and a Tg of between −5° C. and −50° C., are suitable for use. In the case of butadiene-stirene-isoprene copolymers, those with a stirene content of between 5% and 50% by weight and more particularly between 10% and 40%, an isoprene content of between 15% and 60% by weight and more particularly between 20% and 50%, a butadiene content of between 5% and 50% by weight and more particularly between 20% and 40%, a content (mol %) of -1,2 units of the butadiene part of between 4% and 85%, a content (mol %) of trans-1,4 units of the butadiene part of between 6% and 80%, a content (mol %) of -1,2 plus -3,4 units of the isoprene part of between 5% and 70% and a content (mol %) of trans-1,4 units of the isoprene part of between 10% and 50%, and more generally any butadiene-stirene-isoprene copolymer with a Tg of between −5° C. and −70° C., are especially suitable for use.

In summary, the diene elastomer of the composition in accordance with the invention is preferentially chosen from the group of highly unsaturated diene elastomers consisting of polybutadienes (abbreviated as “BR”), synthetic polyisoprenes (IR), natural rubber (NR), butadiene copolymers, isoprene copolymers and mixtures of these elastomers. Such copolymers are more preferentially chosen from the group consisting of butadiene-stirene copolymers (SBR), isoprene-butadiene copolymers (BIR), isoprene-stirene copolymers (SIR) and isoprene-butadiene-stirene copolymers (SBIR).

According to one particular embodiment, the composition comprises from 50 to 100 pce of an SBR elastomer, whether it is an SBR prepared in emulsion (“ESBR”) or an SBR prepared in solution (“SSBR”).

According to another particular embodiment, the diene elastomer is an SBR/BR blend (mixture).

According to other possible embodiments, the diene elastomer is an SBR/NR (or SBR/IR), BR/NR (or BR/IR) or SBR/BR/NR (or SBR/BR/IR) blend.

In the case of an SBR elastomer (ESBR or SSBR), use is made especially of an SBR with an average stirene content, for example, of between 20% and 35% by weight, or a high stirene content, for example from 35 to 45%, a content of vinyl bonds of the butadiene part of between 15% and 70%, a content (mol %) of trans-1,4 bonds of between 15% and 75% and a Tg of between −10° C. and −55° C.; such an SBR may be advantageously used as a mixture with a BR preferably containing more than 90% (mol %) of cis-1,4 bonds.

According to another particular embodiment, the diene elastomer is an isoprene elastomer. The term “isoprene elastomer” means, in a known manner, an isoprene homopolymer or copolymer, in other words a diene elastomer chosen from the group consisting of natural rubber (NR) which may be plasticized or peptized, synthetic polyisoprenes (IR), various isoprene copolymers and mixtures of these elastomers. Among the isoprene copolymers, mention may be made in particular of isobutene-isoprene (butyl rubber—IIR), isoprene-stirene (SIR), isoprene-butadiene (BIR) or isoprene-butadiene-stirene (SBIR) copolymers. This isoprene elastomer is preferably natural rubber or a synthetic cis-1,4 polyisoprene; among these synthetic polyisoprenes, polyisoprenes with a content (mol %) of cis-1,4 bonds of greater than 90% and even more preferentially greater than 98% are preferably used.

According to another preferential embodiment of the invention, the rubber composition comprises a blend of a (one or more) “high Tg” diene elastomer with a Tg of between −70° C. and 0° C. and a (one or more) “low Tg” diene elastomer with a Tg of between −110° C. and −80° C. and more preferentially between −105° C. and −90° C. The high Tg elastomer is preferentially chosen from the group consisting of SSBR, ESBR, natural rubber, synthetic polyisoprenes (with a content (mol %) of cis-1,4 sequences preferably of greater than 95%), BIR, SIR, SBIR and mixtures of these elastomers. The low Tg elastomer preferably comprises butadiene units in a content (mol %) at least equal to 70%; it preferably consists of a polybutadiene (BR) with a content (mol %) of cis-1,4 sequences of greater than 90%.

According to another particular embodiment of the invention, the rubber composition comprises, for example, between 30 and 90 pce and in particular between 40 and 90 pce of a high Tg elastomer as a blend with a low Tg elastomer.

According to another particular embodiment of the invention, the diene elastomer of the composition according to the invention comprises a blend of a BR (as low Tg elastomer) with a content (mol %) of cis-1,4 sequences of greater than 90% with one or more SSBR or ESBR (as high Tg elastomer(s)).

The compositions of the invention may contain only one diene elastomer or a mixture of several diene elastomers.

II.2—Polyether Block Amide (or “PEBA”) Thermoplastic Elastomer

The tire tread according to the invention comprises a rubber composition which has the other essential characteristic of comprising a polyether block amide thermoplastic elastomer.

Polyether block amide thermoplastic elastomers are block polymers comprising polyether blocks and oligoamide blocks, and are also known as polyether block amides. They are obtained by polycondensation of a carboxylic acid end group of a polyamide (of the type PA6, PA11, PA12) with an alcohol end group of a polyether (of the type PTMG polytetramethylene glycol or PEG polyethylene glycol).

The general chemical structure of a polyether block amide thermoplastic elastomer is, in a known manner: HO—(CO-PA-CO—O-PE-O)ₙ—H (in which PA means polyamide and PE means polyethylene). The polyamide blocks give the structure rigidity and are alternated with polyether blocks that give suppleness and resilience.

The rubber composition preferentially comprises more than 5 pce of polyether block amide thermoplastic elastomer, more preferentially from 10 to 50 pce of such an elastomer.

Polyether block amide thermoplastic elastomers are well known and commercially available, for example sold by the company Arkema under the name Pebax.

II.3—Reinforcing Filler

Any type of reinforcing filler known for its capacities for reinforcing a rubber composition that may be used for the manufacture of tires may be used, for example an organic filler such as carbon black, a reinforcing inorganic filler such as silica, or alternatively a blend of these two types of filler, especially a blend of carbon black and silica.

Any carbon black is suitable for use as carbon blacks, especially the “tire-grade” blacks. Among the latter, mention will be made of the reinforcing carbon blacks of the 100, 200 or 300 series (ASTM grades, for instance the blacks N115, N134, N234, N326, N330, N339, N347, N375, or alternatively, depending on the intended applications, the blacks of higher series (for example N660, N683, N772). The carbon blacks may, for example, already be incorporated into an isoprene elastomer in the form of a masterbatch (see, for example, applications WO 97/36724 or WO 99/16600).

As examples of organic fillers other than carbon blacks, mention may be made of functionalized polyvinyl organic fillers as described in applications WO-A-2006/069 792, WO-A-2006/069 793, WO-A-2008/003 434 and WO-A-2008/003 435.

In the present application, the term “reinforcing inorganic filler” should be understood as meaning, by definition, any inorganic or mineral filler (irrespective of its colour and its natural or synthetic origin), also known as “white” filler, “clear” filler or even “non-black filler” as opposed to carbon black, which is capable by itself, without any means other than an intermediate coupling agent, of reinforcing a rubber composition intended for the manufacture of tires, in other words it is capable of replacing, in its reinforcing function, a conventional tire-grade carbon black; such a filler is generally characterized, in a known manner, by the presence of hydroxyl groups (—OH) at its surface.

The physical state in which the reinforcing inorganic filler exists is irrelevant, whether it is in the form of powder, micropearls, granules, beads or any other suitable densified form. Needless to say, the term “reinforcing inorganic filler” also means mixtures of various reinforcing inorganic fillers, in particular of highly dispersible siliceous and/or aluminous fillers as described below.

Reinforcing inorganic fillers that are especially suitable for use are mineral fillers of the siliceous type, in particular silica (SiO₂), or of the aluminous type, in particular alumina (Al₂O₃). The silica used may be any reinforcing silica known to those skilled in the art, especially any precipitated or fumed silica with a BET specific surface area and a CTAB specific surface area that are both less than 450 m²/g, preferably from 30 to 400 m²/g. As highly dispersible precipitated silicas (know as “HDS”), mention will be made, for example, of the Ultrasil 7000 and Ultrasil 7005 silicas from the company Degussa, the Zeosil 1165MP, 1135MP and 1115MP silicas from the company Rhodia, the Hi-Sil EZ150G silica from the company PPG, the Zeopol 8715, 8745 and 8755 silicas from the company Huber and silicas with a high specific surface area as described in application WO 03/16837.

The reinforcing inorganic filler used, in particular if it is silica, preferably has a BET specific surface area of between 45 and 400 m²/g and more preferentially between 60 and 300 m²/g.

Preferentially, the total content of reinforcing filler (carbon black and/or reinforcing inorganic filler such as silica) is between 50 and 200 pce and more preferentially between 100 and 150 pce.

According to one preferential embodiment of the invention, a reinforcing filler comprising between 50 and 150 pce and more preferentially between 50 and 120 pce of inorganic filler is used, particularly silica, and optionally carbon black; carbon black, when it is present, is more preferentially used in a content of less than 20 pce and even more preferentially less than 10 pce (for example between 0.1 and 10 pce).

To couple the reinforcing inorganic filler with the diene elastomer, use is made in a known manner of a coupling agent (or bonding agent) that is at least bifunctional, that is intended to provide a sufficient connection, of chemical and/or physical nature, between the inorganic filler (surface of its particles) and the diene elastomer, in particular of bifunctional polyorganosiloxanes or organosilanes.

Use is made especially of “symmetrical” or “asymmetrical” polysulfide silanes, depending on their particular structure, as described, for example, in applications WO03/002 648 (or US 2005/016 651) and WO03/002 649 (or US 2005/016 650).

Without the definition below being limiting, the polysulfide silanes that are particularly suitable for use are the “symmetrical” ones corresponding to the general formula (I) below:

Z-A-Sₓ-A-Z, in which: (I)
x is an integer from 2 to 8 (preferably from 2 to 5);
A is a divalent hydrocarbon-based radical (preferably C₁-C₁₈ alkylene groups or
C₆-C₁₂ arylene groups, more particularly C₁-C₁₀ and especially C₁-C₄ alkylenes, in particular propylene);
Z corresponds to one the formulae below:

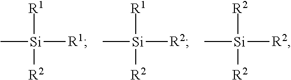

in which:
the radicals R¹, which may be substituted or unsubstituted, and identical or different, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
the radicals R², which may be substituted or unsubstituted, and identical or different, represent a C₁-C₁₈ alkoxy or C₅-C₁₈ cycloalkoxy group (preferably a group chosen from C₁-C₈ alkoxy and C₅-C₈ cycloalkoxy, even more particularly a group chosen from C₁-C₄ alkoxy, in particular methoxy and ethoxy).

In the case of a mixture of polysufide alkoxysilanes corresponding to formula (I) above, especially of the usual commercially available mixtures, the mean value of “x” is a fractional number preferably between 2 and 5, more preferentially close to 4. However, the invention may also advantageously be performed, for example, with disulfide alkoxysilanes (x=2).

As examples of polysulfide silanes, mention will be made in particular of polysulfides (especially disulfides, trisulfides or tetrasulfides) of bis(C₁-C₄)alkoxy(C₁-C₄)alkylsilyl-(C₁-C₄)alkyl, for instance bis(3-trimethoxysilylpropyl) or bis(3-triethoxysilylpropyl)polysulfides. Among these compounds, use is made in particular of bis(3-triethoxysilylpropyl)tetrasulfide, abbreviated as TESPT, of formula [(C₂H_{S}O)₃Si(CH₂)₃S₂]₂ or bis(triethoxysilylpropyl)disulfide, abbreviated as TESPD, of formula [(C₂H_{S}O)₃Si(CH₂)₃S]₂. Mention will also be made, as preferential examples, of bis(mono-(C₁-C₄)alkoxydi(C₁-C₄)alkylsilylpropyl)polysulfides (especially disulfides, trisulfides or tetrasulfides), more particularly bis-monoethoxydimethylsilylpropyl tetrasulfide, as described in patent application WO 02/083 782 (or US 2004/132 880).

As coupling agent other than polysulfide alkoxysilane, mention will be made especially of bifunctional POS (polyorganosiloxanes) or of hydroxysilane polysulfides (R²═OH in formula VIII above) as described in patent applications WO 02/30939 (or U.S. Pat. No. 6,774,255) and WO 02/31041 (or US 2004/051 210), or alternatively silanes or POS bearing azo-dicarbonyl functional groups, as described, for example, in patent applications WO 2006/125 532, WO 2006/125 533 and WO 2006/125 534.

In the rubber compositions in accordance with the invention, the content of coupling agent is preferentially between 4 and 12 pce and more preferentially between 4 and 8 pce.

A person skilled in the art will understand that, as filler equivalent to the reinforcing inorganic filler described in the present paragraph, a reinforcing filler of another nature, especially organic, may be used, provided that this reinforcing filler is covered with an inorganic layer such as silica, or alternatively comprises at its surface functional sites, especially hydroxyls, necessitating the use of a coupling agent to establish the bonding between the filler and the elastomer.

II.4—Various Additives

The rubber compositions of the tire treads in accordance with the invention also comprise all or some of the usual additives commonly used in elastomer compositions intended for the manufacture of treads, for instance pigments, protective agents such as anti-ozone waxes, chemical anti-ozonizing agents, antioxidants, plasticizers other than the abovementioned ones, anti-fatigue agents, reinforcing resins, methylene acceptors (for example novalac phenolic resin) or methylene donors (for example HMT or H3M), a crosslinking system based either on sulfur or on sulfur donors and/or on peroxide and/or bismaleimides, vulcanization accelerators and vulcanization activators.

These compositions may also contain, in addition to the coupling agents, coupling activators, agents for covering the inorganic fillers or, more generally, processing adjuvants which are capable, in a known manner, by virtue of improving the dispersion of the filler in the rubber matrix and of lowering the viscosity of the compositions, of improving their ability to be used in the raw state, these agents being, for example, hydrolysable silanes such as alkylalkoxysilanes, polyols, polyethers, primary, secondary or tertiary amines, or hydroxylated or hydrolysable polyorganosiloxanes.

According to one preferential embodiment, the composition according to the invention also comprises a plasticizer. Preferably, this plasticizer is a solid hydrocarbon-based resin, a liquid plasticizer or a mixture of the two.

The total plasticizer content is preferentially greater than 10 pce, more preferentially between 10 and 100 pce, in particular between 20 and 80 pce, for example between 20 and 70 pce.

According to a first preferential embodiment of the invention, the plasticizer is a liquid plasticizer at 20° C., known as a “low Tg” plasticizer, i.e. which by definition has a Tg of less than −20° C., preferably less than −40° C.

Any extendder oil, whether it is of aromatic or non-aromatic nature, and any liquid plasticizer known for its plasticizing properties on diene elastomers, may be used. At room temperature (20° C.), these plasticizers or these oils, which are more or less viscous, are liquid (i.e., as a reminder, substances which have the capacity of taking over time the shape of their container), as opposed especially to hydrocarbon-based plasticizing resins, which are by nature solid at room temperature.

The liquid plasticizers chosen from the group consisting of naphthenic oils (of high or low viscosity, and especially hydrogenated or non-hydrogenated), paraffinic oils, MES (medium extracted solvate) oils, TDAE (treated distillate aromatic extract) oils, mineral oils, plant oils, plasticizing ethers, plasticizing esters, plasticizing phosphates, plasticizing sulfonates, and mixtures of these compounds, are particularly suitable for use.

Examples of plasticizing phosphates that may be mentioned include those containing between 12 and 30 carbon atoms, for example trioctyl phosphate. Examples of plasticizing esters that may especially be mentioned include the compounds chosen from the group consisting of trimellitates, pyromellitates, phthalates, 1,2-cyclohexane dicarboxylates, adipates, azelates, sebacates, glycerol triesters and mixtures of these compounds. Among the above triesters, mention may be made especially of glycerol triesters preferably consisting predominantly (to more than 50% and more preferentially to more than 80% by weight) of an unsaturated C₁₈ fatty acid, i.e. chosen from the group consisting of oleic acid, linoleic acid and linolenic acid, and mixtures of these acids. More preferentially, whether it is of synthetic or natural origin (in the case, for example, of sunflower or rapeseed vegetable oils), the fatty acid used consists, to more than 50% by weight and more preferentially to more than 80% by weight, of oleic acid. Such triesters (trioleates) with a high content of oleic acid are well known and are described, for example, in application WO 02/088 238, as plasticizers in tire treads.

According to another embodiment of the invention, the content of liquid plasticizer is between 5 and 50 pce, preferentially between 10 and 40 pce and more preferentially between 10 and 35 pce.

According to another preferential embodiment of the invention, this plasticizer is a hydrocarbon-based resin whose Tg is greater than 0° C. and preferably greater than +20° C.

In a manner known to those skilled in the art, the term “resin” is reserved in the present application by definition, to a thermoplastic compound that is a solid at room temperature (23° C.), as opposed to a liquid plasticizer such as an oil.

Preferably, the thermoplastic hydrocarbon-based plasticizing resin has at least any of the following characteristics:
a Tg greater than 20° C. and more preferentially greater than 30° C.;
a number-average molecular mass (Mn) of between 400 and 2000 g/mol and more preferentially between 500 and 1500 g/mol;
a polydispersity index (Ip) of less than 3 and more preferentially less than 2 (reminder: Ip=Mw/Mn with Mw being the weight-average molecular mass).

More preferentially, this hydrocarbon-based plasticizing resin has all of the preferential characteristics above.

The macrostructure (Mw, Mn and Ip) of the hydrocarbon-based resin is determined by steric exclusion chromatography (SEC): tetrahydrofuran solvent; temperature 35° C.; concentration 1 g/l; flow rate 1 ml/min; solution filtered through a filter of porosity 0.45 μm before injection; Moore calibration with polystirene standards; set of 3 Waters columns in series (Styragel HR4E, HR1 and HR0.5); detection by differential refractometer (Waters 2410) and its associated operating software (Waters Empower).

The hydrocarbon-based resins may be aliphatic or aromatic, or alternatively of aliphatic/aromatic type, i.e. based on aliphatic and/or aromatic monomers. They may be natural or synthetic, optionally petroleum-based (if such is the case, they are also known under the name petroleum resins).

Examples of aromatic monomers that are suitable for use include stirene, α-methylstirene, ortho-, meta- and para-methylstirene, vinyltoluene, para-tert-butylstirene, methoxystirenes, chlorostirenes, vinylmesitylene, divinylbenzene, vinylnaphthalene, any vinylaromatic monomer derived from a C₉ fraction (or more generally from a C₈ to C₁₀ fraction). Preferably, the vinylaromatic monomer is stirene or a vinylaromatic monomer derived from a C₉ fraction (or more generally from a C₈ à C₁₀ fraction), Preferably, the vinylaromatic monomer is the minor monomer, expressed in mole fractions, in the copolymer under consideration.

According to one particularly preferential embodiment, the hydrocarbon-based plasticizing resin is chosen from the group consisting of cyclopentadiene (abbreviated as CPD) or dicyclopentadiene (abbreviated as DPCD) homopolymer or copolymer resins, terpene homopolymer or copolymer resins, terpene phenol homopolymer or copolymer resins, C5 fraction homopolymer or copolymer resins, C9 fraction homopolymer or copolymer resins, a-methylstirene homopolymer and copolymer resins, and mixtures of these resins, which may be used alone or in combination with a liquid plasticizer, for example an MES or TDAE oil.

The term “terpene” collates herein, in a known manner, the monomers α-pinene, β-pinene and limonene; a limonene monomer is preferentially used, this compound being, in a known manner, in the from of three possible isomers: L-limonene (levorotatory enantiomer), D-limonene (dextrorotatory enantiomer) or dipentene, which is a racemate of the dextrorotatory and levorotatory enantiomers. Among the above hydrocarbon-based plasticizing resins, mention will be made especially of α-pinene, β-pinene, dipentene or polylimonene homopolymer or copolymer resins.

The above preferential resins are well known to those skilled in the art and commercially available, for example sold as regards:
polylimonene resins: by the company DRT under the name Dercolyte L120 (Mn=625 g/mol; Mw=1010 g/mol; Ip=1.6; Tg=72° C.) or by the company Arizona under the name Sylvagum TR7125C (Mn=630 g/mol; Mw=950 g/mol; Ip=1.5; Tg=70° C.);
C₅ fraction/vinylaromatic copolymer resins, especially C₅ fraction/stirene or C₅ fraction/C₉ fraction: by Neville Chemical Company under the names Super Nevtac 78, Super Nevtac 85 or Super Nevtac 99, by Goodyear Chemicals under the name Wingtack Extra, by Kolon under the name Hikorez T1095 and Hikorez T1100, and by Exxon under the names Escorez 2101 and ECR 373;
limonene/stirene copolymer resins: by DRT under the name Dercolyte TS 105 from the company DRT, or by Arizona Chemical Company under the names ZT115LT and ZT5100.

As examples of other preferential resins mention may also be made of phenol-modified α-methylstirene resins. To characterize these phenol-modified resins, it is recalled that use is made, in a known manner of an index known as the “hydroxyl number” (measured according to standard ISO 4326 and expressed in mg KOH/g). α-Methylstirene resins, especially the phenol-modified resins, are well known to those skilled in the art and are commercially available, for example by the company Arizona Chemical under the name Sylvares SA 100 (Mn=660 g/mol; Ip=1.5; Tg=53° C.); Sylvares SA 120 (Mn=1030 g/mol; Ip=1.9; Tg=64° C.); Sylvares 540 (Mn=620 g/mol; Ip=1.3; Tg=36° C.; hydroxyl number=56 mg KOH/g); Silvares 600 (Mn=850 g/mol; Ip=1.4; Tg=50° C.; hydroxyl number=31 mg KOH/g).

According to one particular embodiment of the invention, the content of hydrocarbon-based plasticizing resin is between 5 and 50 pce, preferentially between 10 and 40 pce and even more preferentially between 10 and 35 pce.

II.5 —Preparation of the Rubber Compositions

The compositions used in the tire treads of the invention may be manufactured in suitable mixers, using two successive preparation phases that are well known to those skilled in the art: a first phase of thermomechanical working or blending (“non-productive” phase) at high temperature, up to a maximum temperature of between 110° C. and 190° C. and preferably between 130° C. and 180° C., followed by a second phase of mechanical working (“productive” phase) up to a lower temperature, typically less than 110° C., for example between 40° C. and 100° C., during which finishing phase the crosslinking system is incorporated.

The process for preparing such compositions comprises, for example, the following steps:
incorporating into a diene elastomer, during a first step (“non-productive” step), at least one reinforcing filler and a polyether block amide thermoplastic elastomer, the whole being thermomechanically blended (for example one or more times) until a maximum temperature of between 110° C. and 190° C. is reached; cooling the mixture to a temperature of less than 100° C.;
next, incorporating during a second step (“productive” step), a crosslinking system;
blending the whole up to a maximum temperature of less than 110° C.

For example, the non-productive phase is formed in a single thermomechanical step during which a suitable mixer such as a common internal mixer is charged, in a first stage, with all the necessary base constituents (the diene elastomer, the reinforcing filler, the polyether block amide thermoplastic elastomer) and then, in second stage, for example after one to two minutes of blending, the other additives, optionally agents for covering the filler or additional processing adjuvants, with the exception of the crosslinking system. The total blending time, in this non-productive phase, is preferably between 1 and 15 minutes.

After cooling the mixture thus obtained, the crosslinking system is then incorporated into an external mixer such as a roll mill, maintained at low temperature (for example between 40° C. and 100° C.). The whole is then mixed (productive phase) for a few minutes, for example between 2 and 15 minutes.

The actual crosslinking system is preferentially based on sulfur and on a primary vulcanization accelerator, in particular an accelerator of sulfenamide type. This vulcanization system is supplemented with various known secondary vulcanization accelerators or activators such as zinc oxide, stearic acid, guanidine derivatives (in particular diphenylguanidine), etc., which are incorporated during the non-productive first phase and/or during the productive phase. The sulfur content is preferably between 0.5 and 3.0 pce, and that of the primary accelerator is preferably between 0.5 and 5.0 pce.

Any compound that is capable of acting as a vulcanization accelerator for diene elastomers in the presence of sulfur may be used as accelerator (primary or secondary), especially accelerators of thiazole type and derivatives thereof, or accelerators of thiuram or zinc dithiocarbamate type. These accelerators are more preferentially chosen from the group consisting of 2-mercaptobenzothiazyl disulfide (abbreviated as MBTS), N-cyclohexyl-2-benzothiazyl sulfenamide (abbreviated as CBS), N,N-dicyclohexyl-2-benzothiazyl sulfenamide (abbreviated as DCB), N-tert-butyl-2-benzothiazyl sulfenamide (abbreviated as TBBS), N-tert-butyl-2-benzothiazyl sulfenimide (abbreviated as TBSI), zinc dibenzyldithiocarbamate (abbreviated as ZBEC) and mixtures of these compounds. A sulfenamide-type primary accelerator is preferably used.

The final composition thus obtained may then be calendered, for example in the form of a sheet, a plate especially for characterization in the laboratory, or extruded, for example to form a rubber profile used for the manufacture of a tread.

The invention concerns the tires described previously both in the raw state (i.e. before curing) and in the cured state (i.e. after crosslinking or vulcanization).

### III—EXAMPLES OF IMPLEMENTATION OF THE INVENTION

III.1—Preparation of the Compositions

The tests that follow are formed in the following manner: the diene elastomer, the polyether block amide thermoplastic elastomer, the reinforcing filler (silica and/or carbon black), and also the various other ingredients with the exception of the vulcanization system are successively introduced into an internal mixer (final degree of filling: about 70% by volume), whose initial tank temperature is about 60° C. Thermomechanical work (non-productive phase) is then performed in one step, which lasts for a total of about 3 to 4 minutes, until a maximum “drop” temperature of 165° C. is reached.

The mixture thus obtained is recovered and cooled, sulfur and a sulfenamide-type accelerator are then incorporated in a mixer (homo-finisher) at 30° C., the whole being mixed (productive phase) for a suitable time (for example between 5 and 12 minutes).

The compositions thus obtained are then calendered either in the form of plates (thickness of 2 to 3 mm) or of thin rubber sheets for measurement of their physical or mechanical properties, or extruded in the form of a tread.

III.2—Tests

The tests that follow show the improvement in the raw-state processability of the tire tread compositions according to the invention, compared with a control tread composition.

To do this, four tread rubber compositions were prepared as indicted previously, three in accordance with the invention (noted below C.2 to C.4) and one not in accordance with the invention (control composition noted C.1 below).

Their formulations are presented in the attached Table 1.

Composition C.1 is a control composition, based on SBR, which may be used in “green tire” treads for private cars.

Compositions C.2 to C.4 are based on SBR and on a polyether block amide thermoplastic elastomer. These compositions differ only from the control composition C.1 by the replacement of, respectively, 10, 20 and 30 pce of SBR with the polyether block amide thermoplastic elastomer. The four compositions are characterized by a very high content of reinforcing filler. They also comprise a plasticizer mixture comprising a hydrocarbon-based resin (polylimonene resin), a liquid plasticizer (oleic acid triester of glycerol) and an MES oil.

The properties of the compositions, before and after curing (vulcanization) are collated in the attached Table 2.

It is noted, unexpectedly, that compositions C.2 to C.4 have a Mooney viscosity value very much lower than that of the control composition C.1, which indicates an appreciable improvement in the processability of these compositions in the raw state.

It is moreover noted that compositions C.2 to C.4 have a greatly improved compromise of properties between the non-crosslinked and crosslinked states. Specifically, the Mooney viscosity of the raw compositions decreases whereas the rigidity of the cured compositions at small deformation (MA10) increases substantially relative to those of the control composition. In addition, the elongation at failure (AR) is improved for compositions C.2 to C.4 in the treads according to the invention.

Finally, the road holding and rolling resistance properties are not appreciably modified, as attested by the tan(S) values measured at 20° C. and 40° C.

In summary, the use of a polyether block amide thermoplastic elastomer makes it possible to greatly improve the processability of the tread rubber compositions according to the invention without appreciably penalizing the road holding and rolling resistance properties of the tires.

TABLE 1

Composition No.

| | C.1 | C.2 | C.3 | C.4 |
|---|---|---|---|---|
| SBR (1) | 100 | 90 | 80 | 70 |
| TPE elastomer (2) | — | 10 | 20 | 30 |
| Filler (3) | 110 | 110 | 110 | 110 |
| Coupling agent (4) | 8.8 | 8.8 | 8.8 | 8.8 |
| Carbon black (5) | 4 | 4 | 4 | 4 |
| Plasticizers (6) | 55 | 55 | 55 | 55 |
| Anti-ozone wax | 1.5 | 1.5 | 1.5 | 1.5 |
| Antioxidant (7) | 2 | 2 | 2 | 2 |
| DPG (8) | 2.1 | 2.1 | 2.1 | 2.1 |
| ZnO (9) | 1.8 | 1.8 | 1.8 | 1.8 |
| Stearic acid (10) | 2 | 2 | 2 | 2 |
| CBS (11) | 1.9 | 1.9 | 1.9 | 1.9 |
| Sulfur | 1.3 | 1.3 | 1.3 | 1.3 |

(1) SSBR solution (contents expressed as dry SBR: 40% stirene, 12% poly(1,2-butadiene) units and 48% poly(1,4-butadiene) units (Tg = −28° C.);
(2) Polyether block amide TPE (Pebax 2533 from the company Arkema);
(3) Silica (Ultrasil 7000 GR from the company Degussa);
(4) Coupling agent TESTP (Si69 from the company Degussa);
(5) Carbon black N234;
(6) Mixture of oleic acid trimester of glycerol (Lubrirob Tod 1880 from the company Novance), of polylimonene resin (Dercolyte L120 from the company DRT) and of SBR extender oil (MES);
(7) N-1,3-Dimethylbutyl-N-phenyl-para-phenylenediamine (Santoflex 6-PPD from the company Flexsys);
(8) DPG = Diphenylguanidine (Perkacit DPG from the company Flexsys);
(9) Zinc oxide (industrial grade-Umicore company);
(10) Stearine (Pristerene from the company Uniqema);
(11) N-Cyclohexyl-2-benzothiazyl sulfenamide (Santocure CBS from the company Flexsys).

TABLE 2

Composition No.

| | C.1 | C.2 | C.3 | C.4 |
|---|---|---|---|---|
| Mooney viscosity | 72 | 58 | 48 | 43 |
| MA 10 | 5.5 | 5.8 | 6.1 | 6.7 |
| AR | 540 | 615 | 700 | 745 |
| Tan (δ) (at 20° C.) | 0.380 | 0.380 | 0.370 | 0.350 |
| Tan (δ) (at 40° C.) | 0.270 | 0.290 | 0.300 | 0.300 |

1. A tire having a tread that comprises a rubber composition comprising at least one diene elastomer, a reinforcing filler and a polyether block amide thermoplastic elastomer.

2. The tire according to claim 1, wherein the diene elastomer is chosen from the group consisting of polybutadienes, synthetic polyisoprenes, natural rubber, butadiene copolymers, isoprene copolymers and mixtures of these elastomers.

3. The tire according to claim 1, wherein the content of polyether block amide thermoplastic elastomer is greater than 5 pce and more preferentially in a range from 10 to 50 pce.

4. The tire according to claim 1, further comprising a plasticizer.

5. The tire according to claim 4, wherein the plasticizer content is greater than 10 pce.

6. The tire according to claim 4, wherein the plasticizer is a thermoplastic hydrocarbon-based resin that has a glass transition temperature greater than 0° C.

7. The tire according to claim 6, wherein the thermoplastic hydrocarbon-based resin is chosen from the group consisting of cyclopentadiene (abbreviated as CPD) or dicyclopentadiene (abbreviated as DPCD) homopolymer or copolymer resins, terpene homopolymer or copolymer resins, terpene phenol homopolymer or copolymer resins, CS fraction homopolymer or copolymer resins, C9 fraction homopolymer or copolymer resins, α-methylstyrene homopolymer or copolymer resins, and mixtures of these resins.

8. The tire according to claim 4, wherein the plasticizer is liquid at 20° C. and has a glass transition temperature of less than 20° C.

9. The tire according to claim 8, wherein the liquid plasticizer is chosen from the group consisting of naphthenic oils, paraffinic oils, MES oils, TDAE oils, plasticizing esters, plasticizing ethers, plasticizing phosphates, plasticizing sulfonates, and mixtures of these compounds.

10. The tire according to claim 4, comprising a hydrocarbon-based resin whose glass transition temperature is greater than 0° C. and a liquid plasticizer that has a glass transition temperature of less than −20° C.

11. The tire according to claim 1, wherein the reinforcing filler comprises carbon black, silica or a mixture of carbon black and silica.

12. The tire according to claim 11, wherein the total content of reinforcing filler is between 50 and 200 pce.

13. The tire according to claim 12, wherein the total content of reinforcing filler is between 100 and 150 pce.
